(19) United States
(12) Patent Application Publication
(10) Pub. No.: US 2026/0331970 A1
(43) Pub. Date: Oct. 22, 2026

(54) STATOR WITH IN-SLOT MOLDING AND COOLING

(71) Applicant: FORD GLOBAL TECHNOLOGIES, LLC, Dearborn, MI (US)

(72) Inventors: Kodie Olshefsky, Detroit, MI (US); Akash Changarankumarath Pradeepkumar, Westland, MI (US); Singar Rathnam, Farmington Hills, MI (US)

(21) Appl. No.: 19/183,369

(22) Filed: Apr. 18, 2025

(51) Int. Cl. H02K 1/16; H02K 1/20; H02K 3/12; H02K 3/30; H02K 3/34; H02K 15/026; H02K 15/121

(52) U.S. Cl. CPC H02K 1/16; H02K 1/20; H02K 3/12; H02K 3/30; H02K 3/345; H02K 15/026; H02K 15/121

(57) ABSTRACT

An electric machine includes a stator with multiple slots, each comprising a body, a step, and a narrower coolant-directing channel. Windings are positioned within the slot bodies but not the channels, and an electrically insulating coating, such as varnish or epoxy resin, is applied to the slot bodies and steps to provide electrical insulation while maintaining cooling efficiency. The slots are liner-less and may accommodate hairpin or nested hairpin windings. To facilitate stator assembly, a molding tool is used to seal the channel during the application of the insulating material so the channel remains open for coolant flow. After curing, the molding tool is removed, allowing for the insertion of windings.

### TECHNICAL FIELD

The present disclosure relates to electric machines.

### BACKGROUND

An electric machine may include a stator and a rotor that cooperate to convert electrical energy into mechanical energy, or vice versa. The conversion of electrical energy to mechanical energy may generate heat.

### SUMMARY

An electric machine includes a stator with multiple slots, each having a body, a narrower coolant-directing channel, and an intermediate step. Windings are positioned within the slot bodies but not the channels, and an electrically insulating coating, such as varnish or epoxy resin, is applied to the slot bodies and steps, creating an insulating barrier between the windings and the stator. The slots are liner-less, and the windings may be hairpin or nested hairpin windings. The stator can incorporate axial or annular coolant passageways, with the channels providing fluid communication for cooling.

A stator assembly station includes a molding tool designed to be placed within the body and step of a stator slot, sealing off a channel while creating a surrounding gap. A dispenser injects an electrically insulating insulator into this gap, with the molding tool preventing the insulator from entering the channel. The assembly station may also include a sleeve to seal the slot from the stator bore. Once the insulator cures, the molding tool is removed, leaving a void in the slot for inserting magnetic windings.

A stator for an electric machine includes stacked laminations forming a stator core with multiple slots, each featuring a body, a narrower step, and an even narrower channel. Windings are positioned within the slot bodies, while an electrically insulating insulator, such as varnish or epoxy resin, is applied within the bodies and steps to partially encase the windings, spacing them from the channels and slot walls. The slots are liner-less, and the stator core may include an annular coolant passageway in fluid communication with the channels.

### BRIEF DESCRIPTION OF THE DRAWINGS

FIG. 1 is a perspective view of a stator.

FIG. 2. is a top perspective view, in cross-section, of the stator of FIG. 1 taken along line A-A.

FIG. 3A is a top perspective view, in cross-section, of the stator of FIG. 1 taken along line B-B.

FIG. 3B is a detail view, in cross-section, of the stator of FIG. 3A taken along lines C-C and D-D with a molding tool in place.

FIG. 3C is a detail view, in cross-section, of the stator of FIG. 3A taken along lines C-C and D-D with the molding tool removed and windings in place.

### DETAILED DESCRIPTION

Detailed embodiments are disclosed herein. These embodiments are merely examples and may be embodied in various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

Directional terms used herein are made with reference to the views and orientations shown in the figures. A central axis is shown in the figures and described below. Terms such as “outer” and “inner” are relative to the central axis. For example, an “outer” surface means that the surfaces face away from the central axis or is outboard of another “inner” surface. Terms such as “radial,” “diameter,” “circumference,” etc. are also relative to the central axis. The terms “front,” “rear,” “upper,” and “lower” designate directions in the drawings to which reference is made. The terms, connected, attached, etc. refer to directly or indirectly connected, attached, etc., unless otherwise indicated explicitly or by context.

The cooling mechanisms described herein affect stator performance by enabling coolant flow within the stator slots for in-slot cooling. This allows the coolant to make direct contact with the magnet wires. In-slot cooling facilitates direct axial cooling of the motor windings, increasing cooling efficiency and supporting continuous motor operation. Additionally, axial cooling enables bi-directional coolant flow within the stator. These cooling mechanisms may include three components: unit 1, which transfers coolant axially from the stator face toward its center; unit 2, which distributes coolant radially around the stator circumference; and/or unit 3, which delivers coolant to each slot of the stator through dedicated ports. The coolant flow transitions from axial to circumferential distribution in unit 2 and from circumferential to radial and axial distribution in unit 3. There is overlap between the second and third cooling units at specific stator laminations, which may occur across adjacent groups of laminations.

In-slot cooling efficiency is affected when material spillage occurs during the manufacture of the stator laminations. This material spillage may create an additional cleaning step to remove any material spillage left behind in the slot or seeped into the cooling channel. If not removed completely, a blockage of coolant flow may occur, preventing cooling of the motor's primary heat source by not allowing coolant to flow to the magnet wires and the stator. Reducing thermal resistance in the magnet wires further affects stator efficiency, allowing the motor to maintain peak performance continuously and operate at higher levels for longer periods. This is achieved without the need for additional heaters, maximizing overall efficiency. A higher power density enables a shorter stator stack length. The system is also scalable, requiring only minor adjustments for implementation across different stators.

The stator lamination slot design includes a stepped feature to accommodate an in-slot molding tool, along with providing a protective stator inner diameter (ID) seal. The lamination feature allows for a mechanical blockage between the in-slot molding tool and an in-slot cooling passageway, which prevents spillage of the molding material into the in-slot cooling passageway. This prevents the molding material from entering the oil passageway and the stator slot opening as these areas are critical for in-slot cooling and protecting the ID of the stator.

The mechanical blockage is a result of the molding tool configured to fit within the stator lamination slot and abut the stepped feature to prevent the molding material from entering the in-slot cooling passageway, while the protective seal positioned on the stator ID prevents the molding material from escaping the slot. Additionally, the molding material remains on an edge of the stepped feature after the molding tool is removed. This remaining molding material is useful in protecting a magnetic wire, positioned in the slot, from direct contact with the steel core while still maintaining the open cooling passageway for the in-slot cooling.

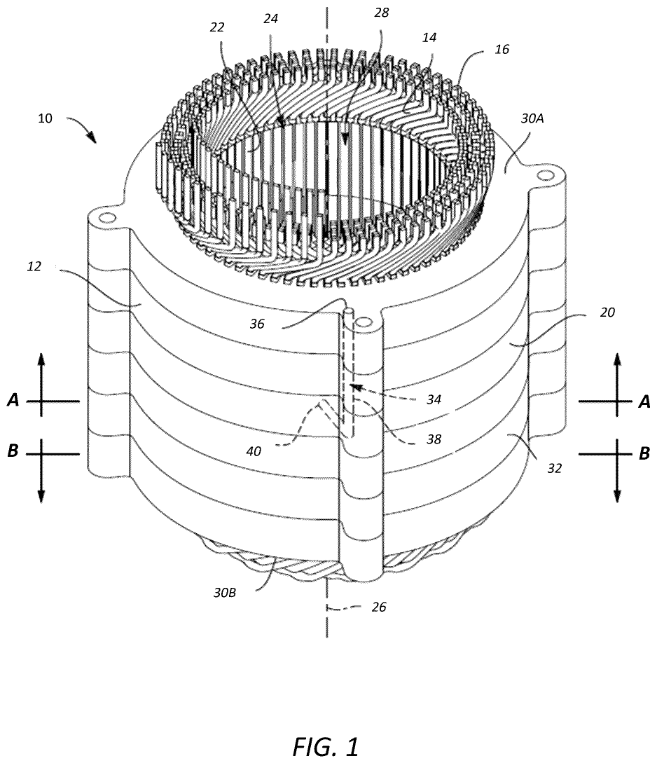

An example stator, identified as stator 10, is shown in FIG. 1. Stator 10 includes a core 12, windings 14, and a high-voltage terminal (not illustrated). Core 12 is made up of multiple stacked laminations 20, with the total number depending on the size requirements of stator 10. For example, core 12 may contain as few as 10 laminations or as many as 5,000. However, other quantities—including fewer than 10, more than 5,000, or any number in between—are also possible and contemplated in this disclosure.

Each lamination 20 in the stack has a top and bottom side. A stack of laminations 20 may be arranged such that the top or bottom side of one lamination 20 is in contact with a corresponding top or bottom side of an adjacent lamination 20 to form the stack. Each lamination 20 has an inner diameter and an outer diameter. When the laminations 20 are stacked, the inner diameter of each collectively forms the inner diameter of stator 10. The inner diameter of stator 10 defines a bore of the stator or cylindrical void 28 extending through the length of stator 10 between the first and last lamination 20 in the stack. The outer diameter of each lamination 20 in the stack collectively forms the outer diameter of stator 10. The outer diameter of stator 10 defines cylindrical face 32 between the first and last lamination 20 in the stack. Stator 10 has a central axis 26, with the plurality of laminations 20 arranged to be aligned and coaxial with central axis 26, making cylindrical void 28 and cylindrical face 32 concentric with central axis 26. Stator 10 further includes axial faces 30A, 30B. The top surface of first lamination 20 in the stack defines axial face 30A, and the bottom surface of last lamination 20 in the stack defines axial face 30B. A normal vector to both axial faces 30A, 30B may be parallel with central axis 26.

Each lamination 20 in the stack includes a plurality of teeth 22 extending radially inward toward the inner diameter of lamination 20. Adjacent teeth 22 of each lamination 20 cooperate to define radially extending slots between teeth 22. When laminations 20 are stacked and oriented so that teeth 22 of adjacent laminations 20 align, the individual slots combine to form a plurality of slots 24 that extend axially through the stator 10 between axial faces 30A, 30B.

Windings 14, also referred to as coils, wires, or conductors, are wrapped around core 12 and disposed within axial slots 24. Windings 14 may be insulated with an electrically insulating insulator, which will be discussed in greater detail below, instead of using a liner. Thus, slot 24 and inserted windings 14 are considered liner-less due to the absence of a liner. Once inserted into the electrically insulated insulator, windings 14 may also be embedded in an additional coating of the electrically insulating insulator or varnish. The electrically insulating insulator and/or varnish may help to stabilize the windings within slots 24. Additionally, the electrically insulating insulator may electrically isolate windings 14 from other portions of stator 10. A portion of windings 14 generally extends in the axial direction along and through slots 24, while at axial faces 30A, 30B, portions of windings 14 curve to form end windings 16. End windings 16 extend beyond axial faces 30A, 30B. Windings 14 may be supported by axial slots 24. Although windings 14 are depicted as hairpin-style windings, other configurations, such as but not limited to, random windings, formed coil windings, lap windings, wave windings, distributed windings, fractional slot windings, bar windings, single layer windings, double layer windings, among others, are also possible.

Stator 10 includes a cooling fluid delivery sub-stack 34. Cooling fluid delivery sub-stack 34 may include cooling fluid inlet port 36, axial passage 38, and cooling fluid outlet port 40. Cooling fluid delivery sub-stack 34 is configured to transfer a cooling fluid axially from axial face 24 toward the center of stator 10 through axial passage 38 that extends through some laminations 20 in the stack. Cooling fluid inlet port 36 is an aperture on axial face 24. Axial passage 38 extends axially from cooling fluid inlet port 36 toward the center of stator 10 in a direction substantially parallel to central axis 26. Axial passage 38 terminates at cooling fluid outlet port 40. Cooling fluid outlet port 40 may be in the center of the stack. The center of the stack may be defined as the middle lamination in the stack. Cooling fluid outlet port 40, however, may be disposed at locations other than the middle of the stack.

Axial passage 38 is formed by adjacent laminations 20 that cooperate to form axial passage 38. For example, a portion of axial passage 38 may be a circular shaped cutout in an individual lamination 20 in the stack. When adjacent laminations 20 having this circular shaped cutout are stacked and aligned, they cooperate to form axial passage 38. A cutout may refer to a hole, aperture, opening, bore, or any other suitable shape that extends through and between the top and bottom surfaces of a lamination 20.

Cooling fluid outlet port 40 is a passage that extends radially inwards through stator 10. Cooling fluid outlet port 40 may be defined by one lamination 20 or multiple laminations 20. Because cooling fluid outlet port 40 traverses radially, rather than axially, adjacent laminations to the ones defines cooling fluid outlet port 40 are required to seal the outlet port 40. In some embodiments, cooling fluid outlet port 40 may be defined by a radially extending cutout that extends radially through a portion of adjacent laminations 20 in the stack. In other embodiments, for example, cooling fluid outlet port 40 is defined by a single lamination 20 in the stack, with adjacent laminations 20 to the one sealing the port 40. Cooling fluid outlet port 40 in this embodiment may be formed at different positions within the stack. The cutouts that define cooling fluid outlet port 40 and a portion of axial passage 38 may be integral to each other and cooperate to form a single structure that facilitates fluid flow without separate junctions or connections. During operation, cooling fluid enters cooling fluid delivery sub-stack 34 via cooling fluid inlet port 36 and flows axially through stator 10 along axial passage 38, and then radially inwards through cooling fluid outlet port 40.

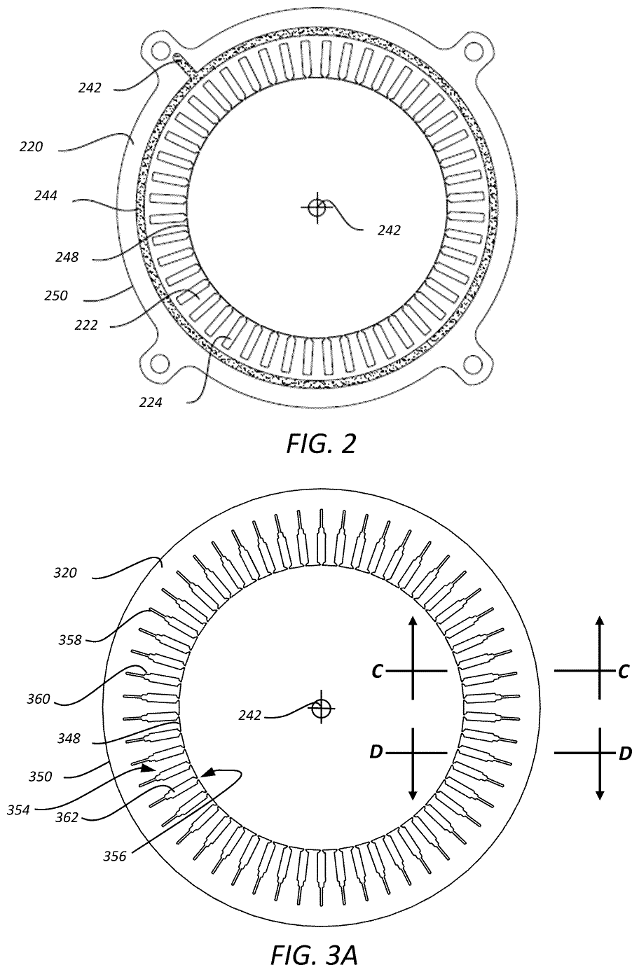

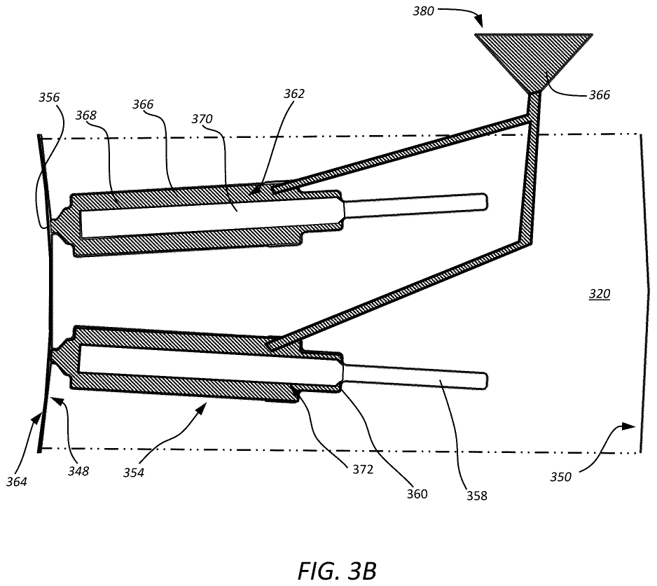

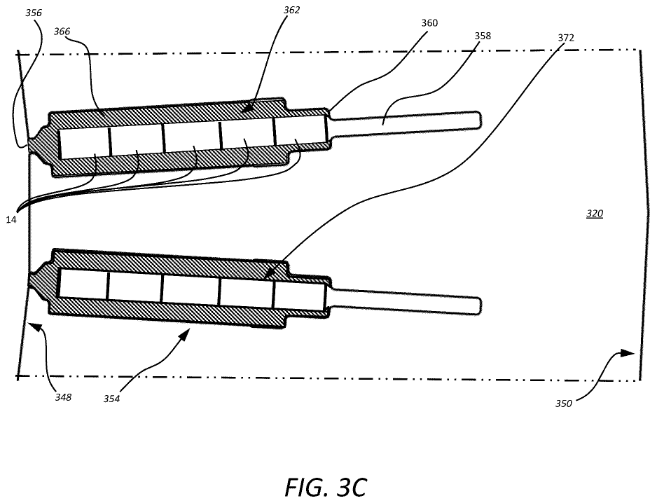

FIG. 2 provides a cross-sectional view of stator 10 taken along line A-A of FIG. 1 and illustrates an embodiment of a lamination 220 having an annular passage 244. As depicted, lamination 220 features a plurality of teeth 222 extending radially inward toward inner circumference 248 of lamination 220. The space between adjacent teeth 222 defines a slot 224. Here the slot 224 is illustrated without a cooling channel, which is illustrated in FIGS. 3A-3C. Laminations 220 and 320 (FIG. 3A) may be used interchangeably and may include the same features though not explicitly illustrated herein. When multiple laminations 220 are stacked and oriented so that teeth 222 of adjacent laminations 220 are aligned, individual slots 224 combine to form continuous axial slots that extend axially through stator 10. When multiple laminations 220 are stacked, inner circumferences 248 and outer circumferences 250 of individual laminations 220 align to form the central void or bore 28 and outer circumference 50 of the stator 10.

Annular passage 244 is a circular channel partially embedded into the surface of lamination 220. In this context, embedded means that passage 244 extends partway through the lamination's thickness rather than being fully enclosed within it or passing completely through. The depth of annular passage 244 may vary based on cooling requirements. For instance, a shallower depth may suffice for lower coolant flow needs, while a deeper passage can increase coolant volume and flow rate for cooling efficiency. Lamination 220 may also include cutout 242. When multiple laminations having cutout 242 are stacked, cutout 242 in adjacent laminations cooperate to form cooling fluid outlet port 240.

FIGS. 3A-3C provide another cross-sectional view of stator 10 taken along line B-B of FIG. 1 and illustrate an embodiment of lamination 320 having a stepped slot 354. FIGS. 3B and 3C illustrate a cross-sectional view of lamination 320 taken along lines C-C and D-D of FIG. 3A and illustrates a detail of the stepped slot 354. As depicted, lamination 320 features a plurality of teeth 322 extending radially inward toward inner circumference 348 of lamination 320. The space between adjacent teeth 322 defines stepped slot 354. As stated previously, when multiple laminations 320 are stacked and aligned, individual slots 324 combine to form continuous axial slots (not illustrated) that extend axially through stator 10. Stepped slot 354 includes opening 356 extending through inner diameter 348 and into axial void or bore 28 of stator 10. Stepped slot 354 further includes a coolant or oil passageway, also known as channel 358 extending radially outward towards outer diameter 350 from stepped slot 354. Channel 358 is in fluid communication with annular passage 244 to receive the supply of coolant as previously discussed. Additionally, a shoulder or step 360 is configured between a stepped slot main cavity or body 362 and channel 358. Step 360 is configured to engage molding tool 370, illustrated in FIG. 3B.

Body 362 has a body width while step 360 has a step width and channel 358 includes a channel width. The step width is narrower than the body width and the channel width is narrower than the step width. This change in width allows molding tool 370 to be placed within body 362 and engage at least a portion of channel 358 to seal channel 358 without completely covering step 360 to allow electrically insulating insulator 366 to fill gap 368 between molding tool 370 and the stepped slot surfaces.

During an electrically insulating insulator filling process, molding tool 370 is inserted into the stepped slot main cavity or body 362 and positioned to abut or engage a portion of step 360 and seal off access to channel 358. Once molding tool 370 is in position, an insulating space or gap 368 is formed between molding tool 370 and stepped slot surfaces, as stated above. Additionally, inner diameter seal 364 is positioned along inner diameter 348 and configured to seal slot opening 356 during the electrically insulating insulator filling process. Inner diameter seal 364 may be a sleeve that is inserted into bore 28 to cover all of the slots of the stacked stators. Once slot opening seal 356 and molding tool 370 are in place, electrically insulating insulator 366 is added or injected into gap 368 with dispenser 380. Dispenser 380 is configured to inject electrically insulating insulator 366 into stator body 362 to flow around molding tool 370 to provide a barrier between metallic stator laminations 320 and stator windings 14 after insertion. Electrically insulating insulator 366 flows around molding tool 370 and fills into gap 368, coating and adhering to walls of body362 and step 360, but not into channel 358.

Once electrically insulating insulator 366 has cured or hardened, molding tool 370 and inner diameter seal 364 are removed leaving a winding cavity or void 372 within stepped slot body 362 such that winding cavity 372 is surrounded by a hardened electrically insulating insulator 366 and is now configured to receive stator windings 14. FIG. 3C shows the positioning of windings 14 extending through stepped slot 354. The illustration shows electrically insulating insulator 366 extending from the surface of step 360 and around gap 368 to isolate windings 14 from the walls or surfaces of lamination 320. The procedure eliminates the need for a liner being positioned within slot 354 prior to inserting windings 14 while still providing insulative properties resulting in a liner-less stator.

Electrically insulating insulator 366 can be a varnish. Other materials, however, may be used including epoxy resin, silicone compounds, polyurethane resins, polyester resins, impregnating gels, thermoplastic insulating materials, ceramic insulators, fluoropolymer coatings, mica-based insulating materials, and more. These materials provide various benefits such as thermal management, mechanical protection, and electrical insulation, catering to different application needs and environmental conditions. Additionally, electrically insulating insulator 366 may be applied more than once to provide a thorough coating and electrical insulation of the components discussed herein. More specifically, the electrical insulation may be applied multiple times during the molding process.

While example embodiments are described above, it is not intended that these embodiments describe all possible forms. Rather, the words used in the specification are words of description rather than limitation, and it is understood that various changes may be made without departing from the spirit and scope of the concepts contemplated. Additionally, the features of various implementing embodiments may be combined to form further embodiments.

What is claimed is:

1. An electric machine comprising:
a stator defining a plurality of slots each having a body, a channel narrower than the body configured to direct a coolant therethrough, and a step narrower than the body and wider than the channel between the body and channel;
windings wound within the bodies but not the channels; and
an electrically insulating insulator coated on surfaces of the bodies and steps but not the channels to define an electrically insulative barrier between the windings and slots such that portions of the electrically insulative insulator separate the windings from the channels.

2. The electric machine of claim 1, wherein the electrically insulating insulator surrounds the windings.

3. The electric machine of claim 1, wherein the slots are liner-less slots.

4. The electric machine of claim 1, wherein the windings are hairpin windings.

5. The electric machine of claim 4, wherein the hairpin windings are nested hairpin windings.

6. The electric machine of claim 1, wherein the electrically insulating insulator is varnish.

7. The electric machine of claim 1, wherein the electrically insulating insulator is epoxy resin.

8. The electric machine of claim 1, wherein the stator further defines an axially extending coolant passageway and the channels are in fluid communication with the axially extending coolant passageway.

9. The electric machine of claim 1, wherein the stator further defines an annular coolant passageway and the channels are in fluid communication with the annular coolant passageway.

10. A stator assembly station comprising:
a molding tool configured to be disposed within a body and step of a slot defined by a stator to seal a channel of the slot from the body and step and to create a gap between surfaces of the body and step and the molding tool such that the gap surrounds the molding tool; and
a dispenser configured to inject an electrically insulating insulator into the gap such that the molding tool prevents the electrically insulating insulator from entering the channel.

11. The stator assembly station of claim 10 further comprising a sleeve configured to be disposed within a bore of the stator to seal the slot from the bore.

12. The stator assembly station of claim 10, wherein the molding tool is configured to be removed from the slot after the electrically insulating insulator is cured to define a void for inserting a plurality of magnetic windings therethrough.

13. A stator for an electric machine comprising:
a plurality of laminations stacked to form a stator core defining a plurality of slots each having a body, a step narrower than the body, and a channel narrower than the step;
a plurality of windings wound within the bodies; and
an electrically insulating insulator disposed within the bodies and steps to partially surround the windings and space the windings from the channels and walls of the bodies.

14. The stator of claim 13, wherein the stator core defines an annular coolant passageway in fluid communication with the channels.

15. The stator of claim 13, wherein the slots are liner-less slots.

16. The stator of claim 13, wherein the electrically insulating insulator is a varnish or epoxy resin.
